(19) United States
(12) Patent Application Publication
(10) Pub. No.: US 2023/0066935 A1
(43) Pub. Date: Mar. 2, 2023

(54) COMPLETE-TYPE ONLINE VOLUNTEER ACTIVITY MANAGEMENT SYSTEM AND METHOD

(71) Applicant: E4NET CO., LTD, Seoul (KR)

(72) Inventor: Su Jeong Lee, Seoul (KR)

(21) Appl. No.: 17/858,074

(22) Filed: Jul. 6, 2022

(30) Foreign Application Priority Data
Aug. 25, 2021 (KR) 10-2021-0112119

(51) Int. Cl. G06Q 10/06; G06Q 10/10; G06Q 50/10

(52) U.S. Cl. CPC G06Q 10/06311; G06Q 10/1091; G06Q 50/10

(57) ABSTRACT

Disclosed are a complete-type online volunteer activity management system and a method thereof. The disclosed complete-type online volunteer activity management system comprises: a volunteer terminal which selects a specific volunteer activity campaign among a plurality of the posed volunteer campaigns and applies for an online volunteer activity; a volunteer group terminal which registers a volunteer activity campaign for posting the volunteer activity campaigns on the volunteer terminal.

### TECHNICAL FIELD

The present invention relates to a volunteer activity management system and a method thereof. More specifically, the present invention relates to a complete-type online volunteer activity management system and a method thereof which are able to allow a user to both perform a volunteer activity and manage the volunteer activity online.

### BACKGROUND ART

Recently, with the concept and importance of social volunteer activity being widely shared, volunteer activities have increased in numbers. In addition, schools give volunteer activity scores to students in accordance with the students' volunteer activities, and more companies recognize volunteer activities of newcomers as a social experience as a part of their career. Accordingly, the importance of the management of volunteer activity is significant.

However, in reality, even if a person wants to do some volunteer activity, the person cannot learn who needs which kind of volunteer activity for how much and when, so the person's intention to perform volunteer activities fails to reach those in need of volunteers. In addition, even those who desperately need the help of volunteers do not know where and how to request it, so it is not easy to receive substantial help.

Accordingly, there are developments of volunteer activity management systems for connecting and managing the applications and requests between those who need volunteer activity and for certifying and managing volunteer activity. Regarding such volunteer activity management systems, disclosed are Korean Patent No. 10-0445532, Korean Patent No. 10-0428074, Korean Patent No. 10-1539973, or the like.

However, the conventional volunteer activity management systems have a structure for performing only the managerial aspects of offline volunteer activities online, so it has not been easy to apply them to online volunteer activities.

### PRIOR ART LITERATURE

### Patent Literature

(Patent Literature 1) Korean Patent No. 10-0445532

(Patent Literature 2) Korean Patent No. 10-0428074

(Patent Literature 3) Korean Patent No. 10-1539973

### DETAILS OF THE INVENTION

### Problem To Be Solved

The present invention has been devised for addressing the above-mentioned problems and aims to provide a complete-type online volunteer activity management system and a method thereof, which are able to manage the application for volunteer activity and output of the online volunteer activity online, automatically calculate the volunteer activity recognition time for the output in a mapping method, and manage and individually notify the volunteer activity history of each volunteer.

But, the purpose of the present invention is not limited to the purpose mentioned above, and the purpose surely includes other purposes or effects that can be identified from the solution of the problem to be solved and embodiments even if they are not clearly mentioned.

### Solution

To this end, in accordance with the present invention, the complete-type online volunteer activity management system comprises: a volunteer terminal which selects a specific volunteer activity campaign among a plurality of posted volunteer activity campaigns and applies for online volunteer activity; a volunteer group terminal which registers a volunteer activity campaign for posting the volunteer activity campaigns on the volunteer terminal; and a volunteer activity management server which registers the volunteer activity campaign provided by the volunteer group terminal, posts the registered volunteer activity campaign, provides an approval information for approving the volunteer activity for the volunteer activity campaign selected by the volunteer terminal to the volunteer terminal, receives volunteer activity output for the volunteer activity campaign submitted by the volunteer terminal, automatically extracts feature elements from the volunteer activity output, automatically calculates the volunteer activity recognition time by a mapping method and transmits the calculated volunteer activity recognition time to the volunteer terminal.

The volunteer activity management server can be configured to compare the volunteer activity output manufacturing time for the volunteer activity output with the official maximum recognition output time for the volunteer activity output and automatically calculate the smaller value as the volunteer activity recognition time.

The volunteer activity management server can be configured to compare the time spent for manufacturing the output written in the result report for the volunteer activity (or the volunteer activity requirement time) with the official maximum output recognition time determined based on the volunteer activity output and automatically calculate the smaller value as the volunteer activity recognition time by the method which prioritizes the minimum value.

The volunteer activity management server is configured to receive the result report including the output manufacturing time along with the volunteer activity output from the volunteer terminal and automatically identify the output manufacturing time for the relevant volunteer activity output based on the volunteer activity output and the result report. The volunteer activity management server can be configured to store the official maximum output time reference table for each type of volunteer activity output and automatically determine the official maximum output recognition time for the output type and the output time extracted based on the volunteer activity output submitted by the volunteer terminal by an automatic verification algorithm.

The volunteer activity output can be made of a PR video made of video, poster, card news or webtoon which are relevant to the volunteer activity campaign and used for an online PR activity.

In addition, the volunteer activity output can be made of output that can be promoted or advertised online in relation to the volunteer activity campaign and output that is made by direct participation in the volunteer event online.

The volunteer activity management server can be configured to calculate a volunteer activity recognition time, store and manage the volunteer activity history information including the volunteer activity recognition time for each volunteer ID, generate an official volunteer activity certificate based on the volunteer activity history information and issue the official volunteer activity certificate generated upon the requests by the volunteer terminal.

In accordance with the present invention, the complete-type online volunteer activity management method can be configured to comprise: a step in which a volunteer group terminal registers a volunteer activity campaign on the volunteer activity management server, and the volunteer activity management server posts the registered volunteer activity campaigns to the volunteer terminal; a step in which the volunteer terminal selects a certain volunteer activity campaign and applies for an online volunteer activity and in which the volunteer terminal submits the manufactured volunteer activity output to the volunteer activity management server; and a step in which the volunteer activity management server automatically calculates a volunteer activity recognition time for the volunteer activity output submitted by the volunteer terminal in a mapping method and stores and manages the volunteer activity history information including the calculated volunteer activity recognition time for each volunteer ID.

The method can be configured to additionally comprise: a step in which, when the volunteer terminal requests a volunteer activity certificate, the volunteer activity management server issues the volunteer activity certificate to the volunteer terminal through a certain identity authentication procedure.

### Effects of the Invention

In accordance with the complete-type online volunteer activity management system and the method thereof, the present invention is able to, totally unlike the conventional fragmentary volunteer activity management system for managing offline volunteer activities, manufacture PR videos including types of videos, posters, card news, and webtoons for promoting not an offline volunteer activity but a volunteer group, provide a platform for allowing volunteers to perform online volunteer activity in various types of online talent donations such as reading books and recording to participate in volunteer activities directly online, grant opportunities for several volunteers to donate their talent and perform the PR activity and in-person volunteer activity of the volunteer groups online thereby contributing to revitalizing volunteer activities by utilizing marketing and expanding the field, and lowering the entry barrier and simplifying the procedure for online volunteer activity by providing an online platform, which leads to increased convenience.

In addition, the present invention is able to automatically calculate the volunteer activity recognition time by mapping volunteer activity output for online volunteer activity and store and manage the volunteer activity history information including the volunteer activity recognition time for each volunteer thereby improving reliability for the volunteer activity recognition and systematically managing the volunteer activity recognition.

### BRIEF DESCRIPTION OF THE DRAWINGS

FIG. 1 is a block diagram of the complete-type online volunteer activity management system in accordance with an embodiment of the present invention.

FIG. 2 is an example drawing of an application screen for online volunteer activity of the present invention.

FIGS. 3 and 4 are example drawings of an output of the online volunteer activity of the present invention.

FIG. 5 is a flowchart of the complete-type online volunteer activity management system in accordance with an embodiment of the present invention.

### SPECIFIC DETAILS FOR IMPLEMENTING THE INVENTION

The present invention may have various changes and diverse embodiments, so it is intended to show specific embodiments in the drawings and describe the specific details for implementing the present invention. However, this is not intended to limit the present invention to a specific embodiment but must be understood to include all changes, equivalences or substitutions included in the idea and technical scope of the present invention. While describing each drawing, similar reference symbols are used for similar components.

Terms such as a first, second, A, and B can be used for describing various components, but such components must not be limited by the terms. The above terms are used only for distinguishing a single component from other components. For instance, a first component can be named as a second component without exceeding the scope of right of the present invention, and likewise, the second component can also be named as the first component. The term “and/or” includes a combination of a plurality of related written items or one from the plurality of related written items.

When it is mentioned that a component is “connected to” or “accessed by” another component, it must be understood that the component may be directly connected to or accessed by the other component, but that any other component may exist in the middle. On the other hand, when it is mentioned that a component is “directly connected to” or “directly accessed by” another component, it must be understood that no other component exists in the middle.

The terms used in the present invention are used just for describing specific embodiments and are not intended to limit the present invention. An expression of a single number includes an expression of a plural number unless it is clearly otherwise meant in the context. In the present invention, terms such as “comprise” and “have” must be understood to designate the existence of characteristics, numbers, steps, operations, components, parts, or combinations of those written in the specifications but not to exclude in advance the existence or possibility to be added of one or more other characteristics, numbers, steps, operations, components, parts, or combinations of those.

Unless otherwise defined, all terms used herein including technological or scientific terms have the same meaning as the general understanding of persons of ordinary skill in the pertinent art in the technical field to which the present invention belongs. Those terms that are the same as those defined in the dictionary used in general must be interpreted to have the same meaning as the meaning of the related technology in the context, and unless clearly defined in the present invention, those terms are not interpreted to have an ideal or excessively formative meaning.

Hereinafter, desirable embodiments of the present invention are described in detail by referring to the attached drawings.

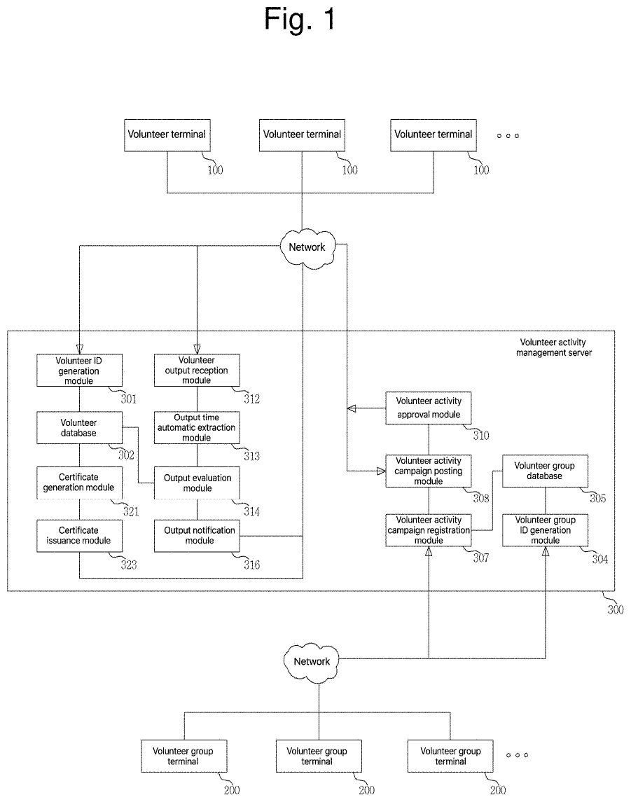

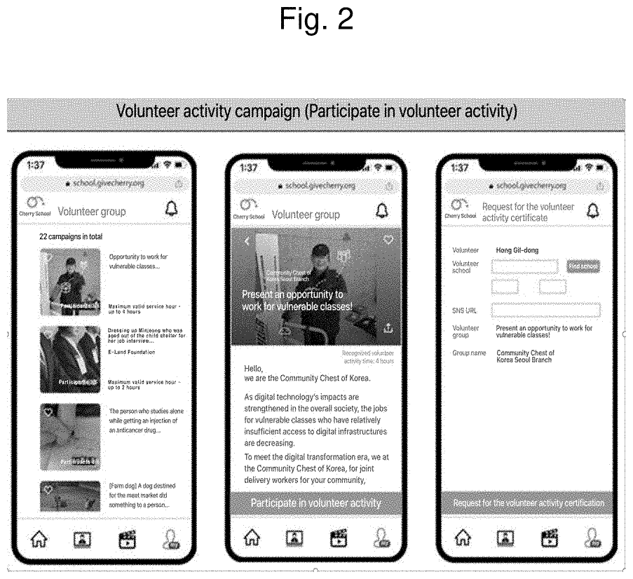

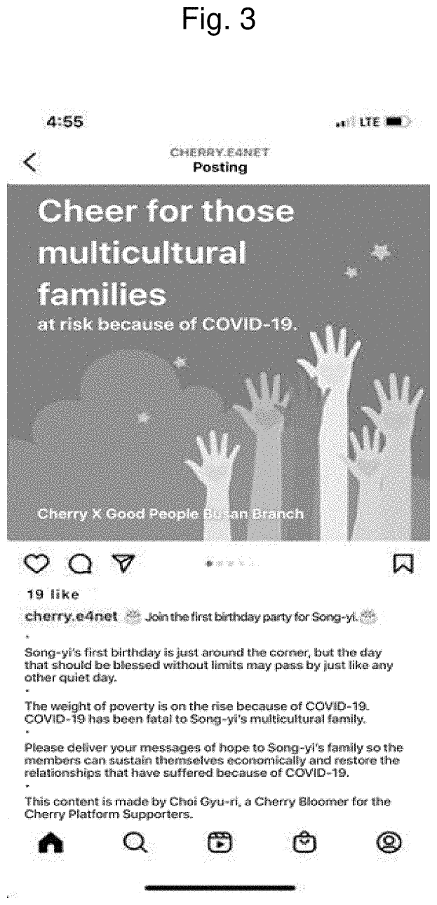

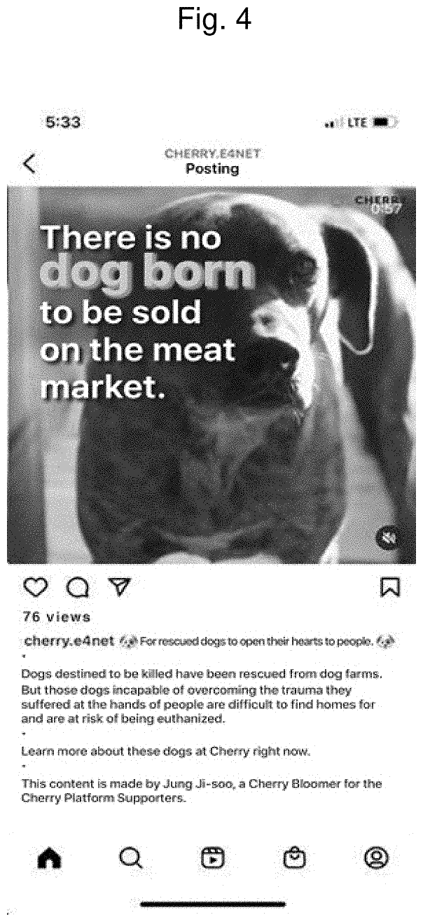

FIG. 1 is a block diagram of the complete-type online volunteer activity management system in accordance with an embodiment of the present invention, and FIG. 2 is an example drawing of a screen for applying for online volunteer activity of the present invention. FIGS. 3 and 4 are example drawings of an output of the online volunteer activity of the present invention.

Referring to FIG. 1, the complete-type online volunteer activity management system in accordance with an embodiment of the present invention is configured to comprise: a volunteer terminal (100); a volunteer group terminal (200); and a volunteer activity management server (300).

The volunteer terminal (100) can be configured to apply for an online volunteer activity and submit an output for the online volunteer activity. The application for the online volunteer activity can be conducted by selecting the online volunteer activity campaign registered and posted on the volunteer activity management server (300) by the volunteer group terminal (200).

The volunteer group terminal (200) can be configured to register the online volunteer activity campaign to the volunteer activity management server (300).

The volunteer activity management server (300) can be configured to post an online campaign provided by the volunteer group terminal (200), manage the volunteer activity application and output by the volunteer terminal (100) online, automatically calculate the volunteer activity recognition time for the output in a mapping method and manage and individually transmit the volunteer activity history for each volunteer.

The volunteer activity management server (300) can be configured to comprise: a volunteer ID generation module (301); a volunteer database (302); a volunteer group ID generation module (304); a volunteer group database (305); a volunteer activity campaign registration module (307); a volunteer activity campaign posting module (308); a volunteer activity approval module (310); a volunteer activity output reception module (312); an output time automatic extraction module (313); an output evaluation module (314); an output notification module (316); a certificate generation module (321); and a certificate issuance module (323).

Hereinafter, the detailed configuration is described.

The volunteer ID generation module (301) can be configured to generate the ID of a volunteer. The volunteer ID generation module (301) generates the volunteer ID upon a request from the volunteer terminal (100), provides the volunteer ID to the volunteer terminal (100) and manages the volunteer activity history for each volunteer and each volunteer ID. The volunteer ID generation module (301) is configured to transmit the volunteer ID to the volunteer group terminal (200) and allow the volunteer group terminal (200) to register the volunteer for each volunteer activity campaign.

The volunteer database (302) is configured to store the volunteer ID generated by the volunteer ID generation module (301) and is configured to store the volunteer activity history information for each volunteer ID.

The volunteer group ID generation module (304) can be configured to generate the ID of the volunteer group. The volunteer group ID generation module (304) generates the volunteer group ID upon a registration request from the volunteer group terminal (200), provides the volunteer group terminal (200) with the volunteer group ID and allows the volunteer activity campaign provided by the volunteer group terminal (200) for each volunteer group ID to be managed.

The volunteer group database (305) is configured to store the volunteer group ID generated by the volunteer group ID generation module (304) and is configured to store the volunteer activity campaign information for each volunteer group ID.

The volunteer activity campaign registration module (307) can be configured to receive the registration of the volunteer activity campaign from the volunteer group terminal (200). The volunteer activity campaign registration module (307) is able to receive the registration request for one or more pieces of volunteer activity campaign information for each volunteer group and store the information in the volunteer group database (305) for each volunteer group ID. Here, the volunteer activity campaign information can include a volunteer activity campaign poster image, campaign PR phrases, etc.

The volunteer activity campaign posting module (308) can be configured to post the volunteer activity campaign registered by the volunteer activity campaign registration module (307) so that each volunteer terminal (100) can check the volunteer activity campaign. Here, the volunteer activity campaign posting module (308) is able to provide the volunteer terminal (100) with the relevant volunteer activity campaign information so that the volunteer activity campaigns registered by a plurality of registered volunteer groups can be posted through an application screen of the volunteer terminal (100).

The volunteer activity approval module (310) can be configured to transmit the volunteer activity approval for the volunteer campaign selected and applied by the volunteer terminal (100) among the posted volunteer activity campaigns to the relevant volunteer terminal (100).

For instance, the volunteer terminal (100) can be configured so that the volunteer activity campaigns of various volunteer groups provided by the volunteer activity campaign posting module (308) can be posted through the application screen, that the volunteer can select a specific volunteer activity campaign through the volunteer terminal (100) and apply for participating in the online volunteer activity, and that the volunteer activity approval module (310) can perform the approval for the volunteer activity campaign selected by the volunteer terminal (100), transmit the approval information to the volunteer terminal (100) and allow the approval information to be checked by the volunteer.

The volunteer terminal (100) can be configured to, when the approval information for the volunteer activity campaign is received from the volunteer activity approval module (310), allow the approval information to be outputted as a notification message such as a popup message and to be checked by the volunteer. By checking the approval information above, the volunteer is able to manufacture a post which is suitable for the selected volunteer activity campaign.

The volunteer terminal (100) can be configured so that a separate post manufacturing module can be included, that a campaign post which is a volunteer activity output related to the selected volunteer activity campaign can be manufactured, and that the manufactured volunteer activity output can be transmitted and submitted to the volunteer activity management server (300).

The volunteer activity output is an online volunteer activity-type output which can be manufactured by video manufacturing tools, poster manufacturing tools, card news manufacturing tools, or the like. As in FIGS. 3 and 4, the output can be configured to be a campaign post for the volunteer activity campaign. In addition, the volunteer activity output can be made of various campaign PR videos such as videos, posters, card news, and webtoons for PR activities for the relevant volunteer activity campaign. In addition, the volunteer terminal (100) can be configured to, when the volunteer activity output is submitted to the volunteer activity management server (300), allow a result report including the manufacturing time information for the volunteer activity output to be submitted together. Meanwhile, in the present invention, the output can be made of book-reading recording files related to the relevant volunteer activity campaign, which are recording files of reading books needed by the blind and children.

Meanwhile, even though the volunteer activity output is described above to be manufactured by a post manufacturing module placed in the volunteer terminal (100), the output is not limited to the post manufacturing module. The volunteer activity output can be configured to be manufactured in a separate terminal which is able to manufacture videos, posters, card news, and webtoons, other than the volunteer terminal (100). In addition, the manufactured volunteer activity output can be transferred to the volunteer terminal (100) to be transmitted and submitted to the volunteer activity management server (300) through the volunteer terminal (100).

The volunteer activity output reception module (312) is configured to receive the volunteer activity output submitted by the volunteer terminal (100) and store and manage the volunteer activity output for each relevant volunteer ID.

The output time automatic extraction module (313) automatically scans the volunteer activity output, analyzes the key elements to be recognized as output and extracts the official maximum output time in a mapping method.

For instance, the output time automatic extraction module (313) is configured so that the official maximum output time is 4 hours for 30-39-second videos, 5 hours for 40-49-second videos, 6 hours for 50-second or longer videos, and 3 hours for card news/webtoon (as of six cuts) for the stored official maximum output time reference table for each type and time of the volunteer activity output. It is also configured to identify the type and size (time) for the volunteer activity output submitted by the volunteer terminal (100) and extract the official maximum output time in a mapping method from the reference table.

That is, the output time automatic extraction module (313) is configured to analyze the type of the relevant volunteer activity output to see whether the volunteer activity output submitted by the volunteer terminal (100) is a PR video, card news or webtoon, analyze the size of the relevant volunteer activity output (the time of videos and the number of cuts of card news/webtoon) and detect the official maximum output time for the relevant volunteer activity output from the reference table.

*50 The output evaluation module (314) is configured to automatically calculate the volunteer activity recognition time in a method which prioritizes the minimum value for the official maximum output time extracted through the output time automatic extraction module (313) and the actually spent manufacturing time presented by an individual on the result report and store the volunteer activity history information including the volunteer activity recognition time for each volunteer ID.

In other words, the output evaluation module (314) can be configured to, based on the result report submitted along with the volunteer activity output from the volunteer terminal (100), identify the output manufacturing time for the relevant volunteer activity output, compare the identified output manufacturing time with the officially recognized maximum output time for the relevant volunteer activity output extracted by the output time automatic extraction module (313) and automatically calculate the smaller value as the volunteer activity recognition time in the method which prioritizes the minimum value.

For instance, if the volunteer activity output is a 30-second PR video, and if the output manufacturing time indicated on the submitted result report is 5 hours, the output evaluation module (314) compares the official maximum output time extracted by the output time automatic extraction module (313), which is 4 hours, with the output manufacturing time, which is 5 hours, and calculates the volunteer activity recognition time for the relevant volunteer activity output to be 4 hours in the method which prioritizes the minimum value. In the same method, if a volunteer activity output is a 30-second video and the manufacturing time indicated in the result report is 3 hours, the output evaluation module (314) can calculate the volunteer activity recognition time for the relevant volunteer activity output to be 3 hours.

Meanwhile, the output evaluation module (314) can, when a volunteer activity output is a 30-second video and the manufacturing time indicated on the result report is 4 hours, which is the same as the official maximum time for a 30-second PR video, calculate the volunteer activity recognition time to be 4 hours.

The output evaluation module (314) is configured to automatically calculate the volunteer activity recognition time for the volunteer activity output and store the volunteer activity history information including the calculated volunteer activity recognition time in the volunteer database (302) for each volunteer ID.

The output notification module (316) can be configured to transmit the volunteer activity recognition time for the volunteer activity output which is automatically calculated in a mapping method by the output evaluation module (314) to the volunteer terminal and allow the volunteer to check the volunteer activity recognition time.

The certificate generation module (321) can be configured to generate an official volunteer activity certificate based on the volunteer activity history information for each volunteer ID stored in the volunteer database (302). This official volunteer activity certificate is a certificate recognized by a government agency and is desirable to be considered as an official volunteer certificate which can be officially used in interviews for schools and companies.

In addition, the official volunteer activity certificate can be configured to include accumulated volunteer activity recognition time for the accumulated online volunteer activity of the relevant volunteer.

The certificate issuance module (323) can be configured to, when the volunteer terminal (100) submits a request for the issuance of the certificate, issue the official volunteer activity certificate generated by the certificate generation module (321) to the volunteer terminal (100). Here, when the certificate issuance is requested by the volunteer terminal (100), the identity authentication procedure on the volunteer terminal (100) should be conducted.

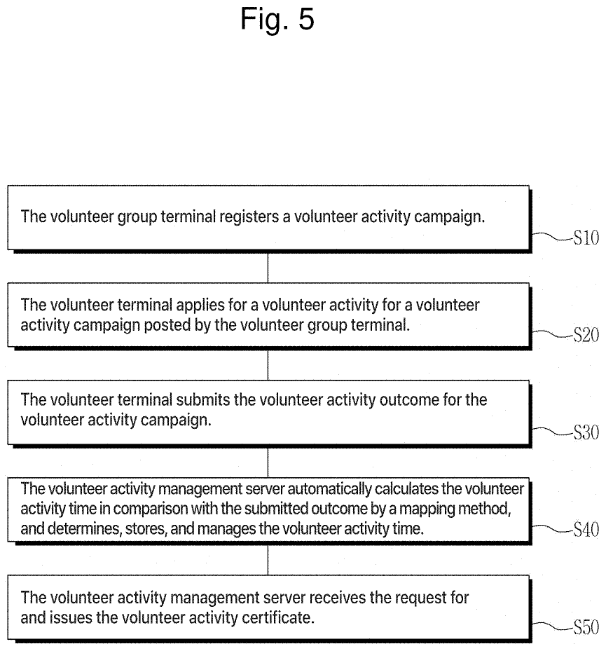

FIG. 5 is a flowchart of the complete-type online volunteer activity management system in accordance with an embodiment of the present invention.

Referring to FIG. 5, the volunteer group terminal (300) registers the volunteer activity campaign to the volunteer activity management server (200) (S10).

Next, the volunteer terminal (100) selects a certain volunteer activity campaign among the volunteer activity campaigns posted by the volunteer group terminal (200) and applies for the online volunteer activity for the relevant volunteer activity campaign (S20).

Next, the volunteer terminal (100) submits the volunteer activity output suitable to the relevant volunteer activity campaign (S30).

Next, the volunteer activity management server (300) automatically calculates the volunteer activity recognition time in the mapping method for the submitted volunteer activity output, stores and manages the volunteer activity history information including the calculated volunteer activity recognition time for each volunteer ID and transmits the relevant history information to the volunteer terminal (100) (S40).

Next, when the volunteer terminal (100) requests the volunteer activity certificate to the volunteer activity management server (300), the volunteer activity management server (300) goes through a certain identity authentication procedure and issues the volunteer activity certificate to the volunteer terminal (100) (S50).

As such, the present invention is shown and described in relation to a desirable embodiment for the principles of the present invention, but the present invention is not limited to the same configuration and operation as the drawings and the descriptions above. Rather, those in the same industry would be able to well understand that many changes and modifications can be made in the present invention without being off the idea and scope of the scope of claim attached. Accordingly, all those proper changes, modifications and equivalences should be considered to be included in the scope of the present invention as well.

### DESCRIPTION OF SYMBOLS

100 . . . Volunteer terminal

200 . . . Volunteer group terminal

300 . . . Volunteer activity management server

301 . . . Volunteer ID generation module

302 . . . Volunteer database

304 . . . Volunteer group ID generation module

305 . . . Volunteer group database

307 . . . Volunteer activity campaign registration module

308 . . . Volunteer activity campaign posting module

310 . . . Volunteer activity approval module

312 . . . Volunteer activity output reception module

313 . . . Output time automatic extraction module

314 . . . Output evaluation module

316 . . . Output notification module

321 . . . Certificate generation module

323 . . . Certificate issuance module

1. A complete-type online volunteer activity management system comprises:
a volunteer terminal which selects a specific volunteer activity campaign among the posted volunteer activity campaigns and applies for the online volunteer activity;
a volunteer group terminal which registers the volunteer activity campaign so that the volunteer activity campaigns can be posted on the volunteer terminal; and
a volunteer activity management server which registers the volunteer activity campaigns provided by the volunteer group terminal, posts the registered volunteer activity campaigns, provides the volunteer terminal with the approval information for approving the volunteer activity for the volunteer activity campaign selected by the volunteer terminal, receives a volunteer activity output on the volunteer activity campaign submitted by the volunteer terminal, automatically calculates a volunteer recognition time in a mapping method for the volunteer activity output and notifies the calculated volunteer activity recognition time to the volunteer terminal,
wherein the volunteer activity output is an output in a type of online volunteer activity which can be manufactured by a video manufacturing tool, poster manufacturing tool, and card news manufacturing tool and is configured to include a campaign post on the volunteer activity campaign, and campaign PR videos including videos, posters, card news, or webtoons which can promote the volunteer activity campaign,
wherein the volunteer activity management server is configured to compare the time spent for manufacturing the output written in the result report for the volunteer activity with the official maximum output recognition time determined based on the volunteer activity output and automatically calculate the smaller value as the volunteer activity recognition time in the method which prioritizes the minimum value,
wherein the volunteer activity management server is configured to receive the result report including the output manufacturing time spent for manufacturing the output along with the volunteer activity output from the volunteer terminal, identify the output manufacturing time for the relevant volunteer activity output based on the result report, automatically scan the volunteer activity output, automatically analyze the key elements to be recognized as an output, automatically extract the official maximum output time in the mapping method, compare the output manufacturing time with the official maximum output time and automatically calculate the smaller value as the volunteer activity recognition time.

2. The complete-type online volunteer activity management system according to claim 1, wherein the volunteer activity management server is configured to calculate a volunteer activity recognition time, store and manage the volunteer activity history information including the volunteer activity recognition time for each volunteer ID, generate an official volunteer activity certificate based on the volunteer activity history information and issue the official volunteer activity certificate generated upon the requests by the volunteer terminal.

3. A complete-type online volunteer activity management method comprises:
a step in which the volunteer group terminal registers the volunteer activity campaign to the volunteer activity management server, and the volunteer activity management server posts the registered volunteer activity campaigns on the volunteer terminal;
a step in which a certain volunteer activity campaign is selected by the volunteer terminal, an application for an online volunteer activity is made, and the volunteer terminal submits a manufactured volunteer activity output to the volunteer activity management server; and
a step in which the volunteer activity management server automatically calculates the volunteer activity recognition time for the volunteer activity output submitted by the volunteer terminal in the mapping method and stores and manages the volunteer activity history information including the calculated volunteer activity recognition time for each volunteer ID,
wherein the volunteer activity output is an output in a type of online volunteer activity which can be manufactured by a video manufacturing tool, poster manufacturing tool, and card news manufacturing tool and is configured to include a campaign post on the volunteer activity campaign, and campaign PR videos including videos, posters, card news, or webtoons which can promote the volunteer activity campaign,
wherein the volunteer activity management server is configured to compare the time spent for manufacturing the output written in the result report for the volunteer activity with the official maximum output recognition time determined based on the volunteer activity output and automatically calculate the smaller value as the volunteer activity recognition time in the method which prioritizes the minimum value,
wherein the volunteer activity management server is configured to receive the result report including the output manufacturing time spent for manufacturing the output along with the volunteer activity output from the volunteer terminal, identify the output manufacturing time for the relevant volunteer activity output based on the result report, automatically scan the volunteer activity output, automatically analyze the key elements to be recognized as an output, automatically extract the official maximum output time in the mapping method, compare the output manufacturing time with the official maximum output time and automatically calculate the smaller value as the volunteer activity recognition time.

4. The complete-type online volunteer activity management method according to claim 3 further comprising: a step in which, when the volunteer terminal requests a volunteer activity certificate, the volunteer activity management server issues the volunteer activity certificate to the volunteer terminal through a certain identity authentication procedure.
